(19) United States
(12) Patent Application Publication
(10) Pub. No.: US 2004/0028874 A1
(43) Pub. Date: Feb. 12, 2004

(54) Fiber-reinforced plastic molded body and method of manufacturing the molded body

(76) Inventors: Hidehiro Takemoto, Toyohashi-shi (JP); Hitoshi Kodama, Toyohashi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,868

(22) PCT Filed: Oct. 29, 2001
(86) PCT No.: PCT/JP01/09470

(30) Foreign Application Priority Data
Oct. 31, 2000 (JP) 2000-331905

(51) Int. Cl. B32B 5/00

(52) U.S. Cl. 428/98; 156/169; 242/159; 428/401

(57) ABSTRACT

A fiber-reinforced plastic molded body with a high production efficiency and a high strength and a method of manufacturing the molded body; the method, comprising the step of vertically feeding reinforced fibers by using a reinforced-fiber wound body for vertical yarn feeding wound with a twist provided thereto in the reverse direction to the twisting direction of and with generally the same number of twists as the twist provided in the vertical feeding of reinforced-fiber bundles with component fibers of 10,000 pieces or more, wherein the number of twists of the reinforced fibers contained in a resulting molded body is substantially zero.

### TECHNICAL FILED

The present invention relates to a fiber-reinforced plastic molded body which is lightweight and has high strength, and particularly, to a fiber-reinforced plastic molded body which can be utilized as a pressure molded body, a body of rotation, a petroleum oil transport pipe and the like for which very high strength is required.

### BACKGROUND ART

Conventionally, steel containers have been used as storage tanks for high-pressure gas. However, because this storage tank is made of a steel material, it is heavy in weight and therefore it takes much labor to move and transport it.

For instance, in the case of using a storage tank made of steel as a fuel storage tank of a vehicle using gaseous fuel, it is desired to lighten even the weight of the fuel storage tank with the intention of lightening a body weight of the vehicle for decreasing fuel consumption. Alternatively, even in the case of gas storage tanks, such as air tanks for fireman or for scuba diving, which a person carries on his shoulder, the tank is desired to be lightweight for a purpose of lightening a burden on a person.

Under the above-mentioned situation, as high-pressure gas storage tanks, storage tanks reinforced by winding fiber-reinforced plastic around a resin or metal liner are being used in place of conventional tanks made of steel. This high-pressure gas storage tank using the fiber-reinforced plastic has succeeded in lightening its weight with keeping strength against a high pressure of gas filled therein.

In the meantime, containers made of steel have been used as a rotor of a flywheel and the like. Storage energy is proportional to the specific strength obtained by dividing strength by density in general. The performance of steel is compared with that of carbon fiber-reinforced plastic and the results are shown in the following table.

TABLE 1

| | | | Specific |
|---|---|---|---|
| Material | Strength (MPa) | Density (kg/m³) | strength |
| Steel | 500 | 7800 | 0.064 |
| Carbon fiber- | 3000 | 1500 | 2.0 |
| reinforced plastic | | | |

As compared with a rotor made of carbon fiber-reinforced plastic, the energy storage performance of a rotor made of steel is about 1/30 of that of a rotor made of carbon fiber-reinforced plastic. Particularly in the case of using the rotor made of steel for mobile products such as vehicles, it is inconvenient because both its size and weight are large. Therefore, fiber-reinforced plastic materials using reinforced fiber such as carbon fiber become used for the rotor at present.

Also, a pipe made of steel has been used as a petroleum oil transport pipe since early times. Crude oil contains hydrogen sulfide and carbonic acid and therefore the transport pipe for the crude oil must have corrosion resistance. Further, the transport pipe must have mechanical durability because petroleum may spout in the state of a pressure as high as 50 to 100 atm depending on the case.

Although the pipe made of steel is inexpensive in general, it has problems concerning corrosion resistance and mechanical durability and therefore, it requires various anti-corrosive treatment and works for the maintenance of corrosive portions. Therefore, fiber-reinforced plastics using reinforced fiber such as carbon fiber also become used as the petroleum transport pipes at present.

As a typical method of winding reinforced fiber in a step of producing various molded products using such fiber-reinforced plastic, a filament winding method (hereinafter referred to as “FW method”) is given as an example. This method is one in which continuous reinforced fiber is wound around an iron core or a plastic liner with applying resin to the fiber and then the resin is cured to produce a molded body.

General fiber feeding systems in this FW method include a system (hereinafter referred to as “pull system”) in which as shown in FIG. 1, a bovine is put vertically to feed fiber in a vertical pulling-out system from an inside or outside thereof and a system (hereinafter referred to as “creel system”) in which as shown in FIG. 2, a bovine is put horizontally and supported by a creel to feed fiber with rotating the bovine under a predetermined back tension.

In the pull system among these feeding systems, the distal end of the fiber in use can be connected with the top of the next fiber in advance, which enables continuous production without suspending the production when exchanging the fiber and hence good productivity. On the contrary, it is undeniable that twists of the fiber are caused when feeding the fiber in a vertical pulling-out system. The twists causes a drop in the strength of the reinforced fiber and hence in the strength of the molded pressure tank, giving rise to the problem that the pressure of the gas filled in the tank is necessarily made low.

In order to deal with these problems, a method of producing fiber-reinforced plastic by feeding yarns in a vertical pulling-out system using glass fiber as the reinforced fiber is disclosed, for example, in Japanese Patent Application Publication (JP-B) No. 1-33342. According to this publication, a roving prepared by arranging plural strands in order parallel to each other is wound cylinder-wise as glass fiber with allowing the fiber to be twisted at a rate of one time per length of a rotation to form a wound body. From this wound body, the roving is pulled in reverse with respect to the twisted direction and the pulled roving is impregnated with liquid thermosetting resin to obtain a glass fiber-reinforced plastic molded body by a filament winding method.

Thus, the hindrance due to a drop in the strength of the plastic molded body even when some twists were added to a glass fiber bundle was eliminated, because the glass fiber bundle used when the technologies for the production of the glass fiber-reinforced plastic molded body as described in this publication was developed unneeded to have such a high strength as mentioned above, the component fibers of the fiber bundle were small in number and the roving had a circular section.

However, in recent years, carbon fiber has been used frequently as reinforced fiber and the number of single fibers constituting a reinforced fiber bundle is substantially increased to several tens of thousands as compared with that used when the aforementioned technologies for the production of the glass fiber-reinforced plastic molded body was developed, in order to improve productivity. Such a fiber bundle having a large number of component fibers is flatted until it is made into the aforementioned wound body. Even if some twists remain, the twisted portion is either bent in the same form that is obtained when a tape is bent or squeezed at the twisted portion so that it is narrowed and therefore shear force is effected among the component fibers to extremely drop the strength required for the fiber-reinforced plastic molded body.

Meanwhile, in the creel system, fiber is not twisted when fed and the creel system has therefore the advantage that the pressure of the gas to be filled can be raised. But, on the other hand, the distal end of the fiber in use cannot be connected in advance with the top of the next fiber to be used. The production must be suspended temporarily for exchanging yarns, resulting in low productivity.

The invention has been made to solve the aforementioned problems and has an object of providing a fiber-reinforced plastic molded body which can be produced without decreasing the production efficiency thereof and possesses high strength.

### DISCLOSURE OF INVENTION

In order to attain such an object, the invention resides in a fiber-reinforced plastic molded body produced by feeding a reinforced fiber bundle in a vertical pulling-out system from a reinforced fiber wound body, the plastic molded body essentially having a structure in which the reinforced fiber bundle wound around the reinforced fiber wound body for feeding in a vertical pulling-out system is constituted of 10000 or more pieces of component fiber and is twisted in reverse with respect to a direction of twists given when the fiber bundle is fed in a vertical pulling-out system, the number of twists is almost the same as the twists given when the fiber bundle is fed in a vertical pulling-out system and the number of twists in the reinforced fiber bundle contained in the plastic molded body is substantially zero.

In the production of the fiber-reinforced plastic molded body of the present invention, first a reinforced fiber wound body for feeding in a vertical pulling-out system is prepared. The number of component fibers of the reinforced fiber bundle wound around the wound body is 10000 or more. If the component fibers are increased in number like this, a fiber-reinforced plastic molded body having a desired thickness is obtained with difficulty when this fiber bundle having a circular section is allowed to be processed as it is in the subsequent steps. In addition, if the number of component fibers is increased, it becomes hard to retain the circular section and the fiber bundle tends to have an ellipsoidal section inevitably. If the section of the fiber bundle is flatted in this manner, the component fibers are bent over a wide range at the twisted portion in the case where even some twists are added to the fiber bundle, with the result that the strength of the fiber-reinforced plastic molded body after produced is greatly decreased locally.

Therefore, in the case of using the reinforced fiber bundle having a large number of component fibers as aforementioned, the fiber bundle after fed, particularly, in a vertical pulling-out system must not have even a little twists. Accordingly, the wound body of the reinforced fiber bundle used in the invention is wound with the fiber bundle being twisted in reverse with respect to the direction of and with the number of twists being the same as that of the twists given inevitably when the fiber bundle is fed in a vertical pulling-out system. The number of twists given to this wound body is preferably in a range from 0.1 to 2 (rotations/turn) and more preferably in a range from 0.5 to 1.5 (rotations/turn). To mention with emphasis, it is important that the direction of the twists given to this wound body is reverse to that of the twists given inevitably when the fiber bundle is fed in a pull system. A direction of the twists given to the wound body is any one of an S-direction; clockwise with respect to the direction of the fiber or a Z-direction; anticlockwise with respect to the direction of the fiber.

The reinforced fiber bundle is fed from such a reinforced fiber wound body in a vertical pulling-out system and further the fiber bundle is coated with resin. Then, the coated fiber bundle is wound around a surface of a metal or resin liner and thereafter the resin is cured to produce a fiber-reinforced plastic molded body such as a pressure tank.

According to the invention, as aforementioned, the fiber bundle is fed in the pull system from the reinforced fiber wound body with twists given thereto in advance in reverse with respect to the direction of the twists given inevitably when the fiber bundle is fed. Therefore, by this feeding, twists are given to the fiber bundle in reverse with respect to the direction of the twists given previously, so that the fiber bundle with the twists previously given thereto is detwisted when it is fed and therefore the reinforced fiber bundle is supplied in a substantially non-twisted state. In the fiber-reinforced plastic molded body of the invention obtained in this manner, the number of twists of the reinforced fiber bundle contained in the plastic molded body is substantially zero. Therefore, the molded body eventually has high strength because the characteristic of the reinforced fiber are effected satisfactorily.

In the invention, the fiber bundle is fed in the pull system from the reinforced fiber wound body twisted in advance in reverse with respect to the direction of the twists given inevitably when the fiber bundle is fed. It is theoretically possible that the number of twists of the reinforced fiber bundle contained in the molded body is made to be zero by controlling the number of twists given in advance to the wound body and the number of twists given inevitably when the fiber bundle is fed. However, in actual, there is the case where some twists are given to the reinforced fiber bundle contained in the resulting molded body. The number of twists of the reinforced fiber bundle contained in the molded body of the invention is preferably in a range from 0 to 1 (rotations/m).

The upper limit of this range is a maximum of the number of twists observed in the reinforced fiber bundle of the actually produced molded body of the invention. Also, the lower limit of the range is the upper limit of twists existing in the reinforced fiber bundle contained in the molded body obtained by producing by the aforementioned feeding in a horizontal pulling-out system. Although the number of twists of the reinforced fiber bundle contained in the molded body of the invention is larger than that of the reinforced fiber bundle contained in the molded body produced by feeding in the horizontal pulling-out system, the characteristics of reinforced fiber can be sufficiently exhibited and also the obtained strength of the resulting molded body is the same as that of the molded body produced by feeding in the horizontal pulling-out system if the number of twists falls in the above range.

In addition, since the reinforced fiber bundle is fed in the vertical pulling-out system (pull system) as mentioned above, the distal end of the reinforced fiber wound body is connected with the top of the next reinforced fiber wound body to thereby make continuous production possible without suspending or decelerating the production apparatus even when exchanging yarns. Therefore, the fiber-reinforced plastic molded body of the invention can be produced highly efficiently.

In a method of measuring the number of twists given to the reinforced fiber bundle of the aforementioned reinforced fiber wound body, the wound body is set to a creel or the like and the number of twists produced in the fiber when pulling a fiber bundle with a length corresponding to 10 turns in such a manner as to prevent twisting when feeding the fiber is measured five times to calculate an average which is expressed as the number of twists.

Further, in the invention, the width W of the reinforced fiber bundle to be fed from the above reinforced fiber wound body is preferably 4.0 (mm) or more, and more preferably 6.0 (mm) or more. In the invention, the sectional shape of the reinforced fiber bundle to be fed from the reinforced fiber wound body is preferably as flat as possible because not only the fiber bundle is easily impregnated with resin evenly but also a fiber-reinforced plastic molded body with a desired thickness is easily obtained. If the width W of the reinforced fiber bundle is particularly less than 4.0 (mm), the thickness of the reinforced fiber bundle is relatively increased, so that even impregnation with resin is not expected and it is therefore difficult to obtain a fiber-reinforced plastic molded body with a thin thickness.

No particular limitation is imposed on the material of the reinforced fiber to be used in the invention, and carbon fiber, glass fiber, alamide fiber and the like may be used. Particularly in the invention according to claim 2, the above reinforced fiber is characterized by a tow strength of 4.0 GPa or more and an elastic modulus of 220 GPa or more. The use of fiber having the above tow strength and elastic modulus enables the obtention of a fiber-reinforced plastic molded body superior in strength characteristics. Further, there is no particular limitation to the number of reinforced fibers to be supplied and one or plural fibers may be used. Moreover, plural types of reinforced fiber may be used.

### BRIEF DESCRIPTION OF THE DRAWINGS

FIG. 1 is a conceptual view of a method of feeding in a pull system.

FIG. 2 is a conceptual view of a method of feeding in a creel system.

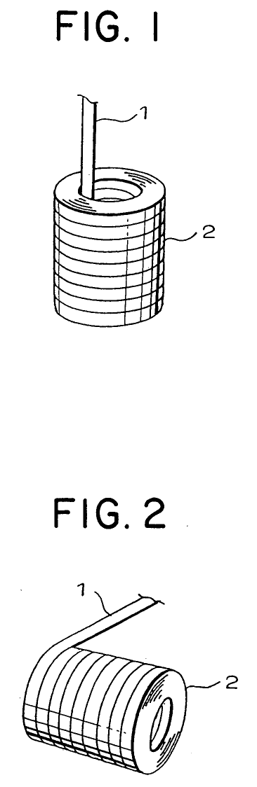

### BEST MODE FOR CARRYING OUT THE INVENTION

Preferred examples of the invention will be explained with detailed examples and comparative examples.

### EXAMPLE 1

A spool was prepared which was obtained by winding a carbon fiber tow (Pyrofile TRH50-ALA-24K, manufactured by Mitsubishi Rayon Co., Ltd., fiber width: 6.07 mm and fiber thickness: 0.18 mm) made of component fibers of 24000 pieces around a core having a diameter of 76.2 mm with giving one (rotations/turn) twist in advance to the tow clockwise with respect to the running direction of the fiber. The paper tube of the core was torn and removed from the spool and the tow was pulled from the inside of the spool by using a four-axis control filament winding machine having to feed the tow in the vertical pulling-out system (pull system). The number of fibers to be fed at this time was 5. When feeding in the pull system here, it was intended to give about one (rotation/turn) twist to the tow counterclockwise with respect to the direction of the fiber. The number of twists of each spool was measured five times in advance, to find that it was 0.9 to 1.2 (rotations/turn) in average.

An aluminum liner having a diameter φ of 300 mm, a length of 800 mm and an average thickness of 4 mm was set to the filament winding machine. The carbon fiber tow was coated with epoxy resin (#700B, manufactured by Mitsubishi Rayon Co., Ltd.) and then wound with a required laminate structure in a plate thickness of about 12 mm. The fiber-wound liner was placed in a curing furnace and cured at 150° C. for 3 hours and then cooled to ambient temperature for 3 hours to obtain a tank made of carbon fiber-reinforced plastic. The theoretical average of the number of twists of the reinforced fiber contained in the tank was 0.15 (rotations/m), which was substantially zero.

### COMPARATIVE EXAMPLE 1-1

A spool obtained by winding a carbon fiber tow (Pyrofile TRH50-ALA-24K, manufactured by Mitsubishi Rayon Co., Ltd.) by a usual method without giving any twists was set to the four-axis control filament winding machine to feed the fiber in the creel system. The number of fibers to be fed at this time was 5. In the same manner as in Example 1, an aluminum liner having a diameter φ of 300 mm, a length of 800 mm and an average thickness of 4 mm was set to the filament winding machine. The carbon fiber tow was coated with epoxy resin (#700B, manufactured by Mitsubishi Rayon Co., Ltd.), wound and cured to obtain a tank made of carbon fiber-reinforced plastic. No twist was added to the reinforced fiber contained in the resulting tank.

### COMPARATIVE EXAMPLE 1-2

From a spool obtained by winding a carbon fiber tow (Pyrofile TRH50-ALA-24K, manufactured by Mitsubishi Rayon Co., Ltd.) around a core having a diameter of 76.2 mm without giving any twists by using the same filament winding machine that was used in the above Example 1 in a usual method, the paper tube of the core was removed. The spool was placed on a floor and the tow was fed in a so-called pull system in which the tow was pulled from the inside of the spool. The number of fibers to be fed at this time was made to be 5 like Example 1. Further, an aluminum liner having a diameter φ of 300 mm, a length of 800 mm and an average thickness of 4 mm was set to the filament winding machine in the same manner as in Example 1. The carbon fiber tow was coated with epoxy resin (#700B, manufactured by Mitsubishi Rayon Co., Ltd.), wound around and cured in the same manner as in Example 1 to obtain a tank made of carbon fiber-reinforced plastic. The number of twists of the reinforced fiber tow contained in the tank was 2.7 (rotations/m) in theoretical average.

The carbon fiber-reinforced plastic tanks of the above Example 1 and Comparative Examples 1-1 and 1-2 were respectively set to a hydraulic breakdown tester. Three tanks of each example were hydraulically ruptured to measure burst pressure, thereby obtaining the following results.

Example 1: 116.3 MPa

Comparative Example 1-1: 118.1 MPa

Comparative Example 1-2: 86.2 MPa

The tank of Example 1 obtained by feeding in the pull system using a creel with twists given thereto in reverse with respect to the direction of the twists given inevitably when feeding in the pull system had the same burst pressure as the tank of Comparative Example 1-1 obtained by feeding in the creel system and the percentage of a reduction in strength was about 2% at most as compared with the tank of Comparative Example 1-1. This reason is that the twists given in advance are released by the twists added inevitably when feeding in the pull system, the reinforced fiber tow is wound around the liner in substantially no twisted state, and the number of twists added to the reinforced fiber contained in the resulting tank is as small as 0.15 (rotations/m), which is substantially zero. Therefore, the strength of the reinforced fiber can be sufficiently exhibited to thereby obtaining a highly strengthened tank.

On the contrary, it was clarified that the tank of Comparative Example 1-2 obtained by feeding in the pull system from the usual creel with no twist given thereto was reduced in strength by as large as about 27% when compared with the tank of Comparative Example 1-1. This is because the reinforced fiber tow is wound around the liner in a twisted state because the tow is fed in the pull system. The number of twists added to the reinforced fiber tow contained in the resulting tank is as large as 2.9 (rotations/m) and the strength of the reinforced fiber can be insufficiently exhibited, causing reduced strength.

### EXAMPLE 2

A spool was prepared which was obtained by winding a carbon fiber tow (Pyrofile TRH50-ALA-24K, manufactured by Mitsubishi Rayon Co., Ltd.) around a core having a diameter of 76.2 mm with giving one (rotation/turn) twist in advance to the tow clockwise with respect to the running direction of the fiber. The paper tube of the core was torn and removed from the spool and the tow was pulled from the inside of the spool by using a three-axis control filament winding machine to feed the tow in a vertical pulling-out system (pull system). The number of fibers to be fed at this time was 5. When feeding in the pull system here, it was intended to give about one (rotation/turn) twist to the tow counterclockwise with the direction of the fiber. The number of twists of each spool was measured five times in advance, to find that it was 0.9 to 1.2 (rotations/turn) in average.

A steel mandrel having a diameter φ of 300 mm and a length of 100 mm was set to the filament winding machine. The carbon fiber tow was coated with epoxy resin (#700B, manufactured by Mitsubishi Rayon Co., Ltd.) and then wound around the mandrel with a structure of only peripheral winding in a plate thickness of about 50 mm. The liner around which the fiber tow was wound was placed in a curing furnace and cured at 150° C. for 3 hours and then cooled to ambient temperature for 3 hours to obtain a rotor made of carbon fiber-reinforced plastic. The theoretical average of the number of twists of the reinforced fiber tow contained in the rotor was 0.06 (rotations/m), which was substantially zero.

### COMPARATIVE EXAMPLE 2-1

A spool obtained by winding the same carbon fiber tow (Pyrofile TRH50-ALA-24K, manufactured by Mitsubishi Rayon Co., Ltd.) that was used in Example 2 by a usual method without giving any twists was set to the three-axis control filament winding machine to feed the fiber in the creel system.

The number of fibers to be fed at this time was 5. A steel mandrel having a diameter φ of 300 mm and a length of 100 mm was set to the filament winding machine, in the same manner as in Example 1. The carbon fiber tow was coated with epoxy resin (#700B, manufactured by Mitsubishi Rayon Co., Ltd.) and wound around the mandrel and the resin was cured in the same manner as in Example 2 to obtain a rotor made of carbon fiber-reinforced plastic. No twist was added to the reinforced fiber tow contained in the resulting rotor.

### COMPARATIVE EXAMPLE 2-2

From a spool obtained by winding the same carbon fiber tow (Pyrofile TRH50-ALA-24K, manufactured by Mitsubishi Rayon Co., Ltd.) around a core having a diameter of 76.2 mm without giving any twists by using the same filament winding machine that was used in the above Example 2 in a usual method, the paper tube of the core was removed. The spool was placed on a floor and the tow was fed in a so-called pull system in which the tow was pulled from the inside of the spool. The number of fibers to be fed at this time was made to be 5 like Example 2. Further, a steel mandrel having a diameter φ of 300 mm and a length of 100 mm was set to the filament winding machine in the same manner as in Example 2. The carbon fiber tow was coated with epoxy resin (#700B, manufactured by Mitsubishi Rayon Co., Ltd.) and wound around the mandrel and the resin was cured in the same manner as in Example 2 to obtain a rotor made of carbon fiber-reinforced plastic. The number of twists added to the reinforced fiber tow contained in the resulting rotor was 3.1 (rotations/m) in theoretical average.

An aluminum hub with a shaft was attached to each of the rotors and rotors were then set to a turbine system rotary breakdown tester respectively. Three rotors of each example were ruptured by centrifugal force to measure burst pressure, thereby obtaining the following results.

Example 2: 116×103 rpm

Comparative Example 2-1: 118×103 rpm

Comparative Example 2-2: 86×103 rpm

It was clarified that the rotor of Comparative Example 2-2 obtained by feeding the reinforced fiber in the pull system from the usual spool was reduced in strength by as large as about 27% when compared with the rotor of Comparative Example 2-1 obtained by feeding the reinforced fiber tow in the creel system with no twist given thereto when feeding.

It is because twists was inevitably given to the fiber tow when the reinforced fiber tow was fed in the pull system and the reinforced fiber tow was wound around the mandrel in a condition that twists were added to the fiber tow, so that in the resulting rotor, the strength characteristics of the reinforced fiber was insufficiently exhibited.

On the contrary, the rotor of the invention produced by feeding the reinforced fiber tow in the pull system from a creel to which twists are given in advance in reverse with respect to the direction of twists given inevitably when feeding in the pull system was reduced in strength only by a ratio of about 2% when compared with that of Comparative Example 2-1 and therefore the rotor of the invention had sufficient strength. It is because twists is given in a direction reverse to the direction of the twists given in advance since the creel with twists given thereto in a reverse direction in advance is used, so that the previous twists are released and the reinforced fiber tow is wound around the mandrel in a substantially untwisted state if the reinforced fiber tow is fed in a pull system. Therefore, the resulting rotor has the same high-speed rotation performance as that of the Comparative Example 2-1 obtained by feeding in a creel system because the strength characteristics of the reinforced fiber tow are exhibited sufficiently.

### EXAMPLE 3

A spool was prepared which was obtained by winding a carbon fiber tow (Pyrofile TRH50-ALA-24K, manufactured by Mitsubishi Rayon Co., Ltd.) around a core having a diameter of 76.2 mm with giving one (rotation/turn) twist in advance to the tow clockwise with respect to the running direction of the fiber. The paper tube of the core was torn and removed from the spool and the tow was pulled from the inside of the spool by using a three-axis control filament winding machine to feed the tow in a vertical pulling-out system (pull system). The number of fibers to be fed at this time was 5. When feeding in the pull system here, it was intended to give about one (rotation/turn) twist to the tow counterclockwise with the direction of the fiber. The number of twists of each spool was measured five times in advance, to find that it was 0.9 to 1.2 (rotations/turn) in average.

A steel mandrel having a diameter φ of 100 mm and a length of 5,000 mm was set to the filament winding machine. The carbon fiber tow was coated with epoxy resin (#700B, manufactured by Mitsubishi Rayon Co., Ltd.) and then wound around the mandrel by bias winding at an angle of ±60° to 45° in a plate thickness of about 5 mm. The fiber wound liner was placed in a curing furnace and cured at 150° C. for 3 hours and then cooled to ambient temperature for 3 hours to obtain a petroleum transport pipe made of carbon fiber-reinforced plastic. The number of twists of the reinforced fiber tow contained in the resulting pipe was 0.11 (rotations/m), which was substantially zero.

### COMPARATIVE EXAMPLE 3-1

A spool obtained by winding the same carbon fiber tow (Pyrofile TRH50-ALA-24K, manufactured by Mitsubishi Rayon Co., Ltd.) that was used in Example 3 by a usual method without giving any twists was set to a three-axis control filament winding machine to feed the fiber in the creel system. The number of fibers to be fed at this time was 5. A steel mandrel having a diameter φ of 100 mm and a length of 5,000 mm was set to the filament winding machine, in the same manner as in Example 3. The carbon fiber tow was coated with epoxy resin (#700B, manufactured by Mitsubishi Rayon Co., Ltd.) and wound around the mandrel and the resin was cured in the same condition as in Example 3 to obtain a petroleum transport pipe made of carbon fiber-reinforced plastic. No twist was added to the reinforced fiber tow contained in the resulting pipe.

### COMPARATIVE EXAMPLE 3-2

A spool obtained by winding the same carbon fiber tow (Pyrofile TRH50-ALA-24K, manufactured by Mitsubishi Rayon Co., Ltd.) that was used in Example 3 around a core having a diameter of 76.2 mm without giving any twists in a usual method was placed on a floor after the paper tube of the core was torn and removed, and the spool was fed in a so-called pull system in which the tow was pulled from the inside of the spool to mold a petroleum transport pipe. The number of fibers to be fed at this time was made to be 5. A steel mandrel having a diameter φ of 100 mm and a length of 5,000 mm was set to the filament winding machine in the same manner in Example 3. The carbon fiber tow was coated with epoxy resin (#700B, manufactured by Mitsubishi Rayon Co., Ltd.) and wound around the mandrel and the resin was cured in the same condition as in Example 3 to obtain a petroleum transport pipe made of carbon fiber-reinforced plastic. The number of twists added to the reinforced fiber tow contained in the resulting pipe was 3.4 (rotations/m).

Each of these petroleum transport pipes was set to a hydraulic breakdown tester. Three pipes of each example were ruptured by internal pressure to measure burst pressure, thereby obtaining the following results.

Example 3: 51 MPa

Comparative Example 3-1: 51 MPa

Comparative Example 3-2: 37 Mpa

It was clarified that the strength of the petroleum transport pipe of Comparative Example 3-2 obtained by feeding the reinforced fiber tow in the pull system from the usual spool (a spool with no twist given thereto in advance) was smaller by as large as about 27% than that of the petroleum transport pipe of Comparative Example 3-1 obtained by feeding the reinforced fiber tow in the creel system with no twist given thereto. The reason why the strength of the petroleum transport pipe of Comparative Example 3-2 was decreased was that when the reinforced fiber tow was fed in the pull system, twists were inevitably given to the fiber tow and the reinforced fiber tow was wound around the mandrel in the condition that twists was added to the fiber tow, so that the strength characteristics of the reinforced fiber was insufficiently exhibited.

On the contrary, the petroleum transport pipe of Example 3 produced by feeding the reinforced fiber tow in the pull system from a creel to which twists are given in advance in reverse with respect to the direction of twists given inevitably when feeding in the pull system was not judged to be more reduced in strength than that of Comparative Example 3-1 and had sufficient strength. It is because the previous twists are released by the twists given when the reinforced fiber tow is fed in the pull system since the creel with twists given thereto in a reverse direction in advance is used, so that the reinforced fiber tow is therefore wound around the mandrel in a substantially untwisted state. Therefore, the resulting pipe had the same corrosion resistance and mechanical durability as the pipe of Comparative Example 3-1 obtained by feeding the reinforced fiber tow in the creel system since the strength characteristics of the reinforced fiber is sufficiently exhibited.

Besides the foregoing Examples 1 to 3, tanks made of carbon fiber-reinforced plastic were obtained using the same carbon fiber tow (Pyrofile TRH50-ALA-24K, manufactured by Mitsubishi Rayon Co., Ltd.) under the same condition as in Example 1 except that the width W of the tow was variously altered. The number of twists of the reinforced fiber contained in the resulting tank was substantially zero in all cases. However, when the width of the tow was less than 4.0 (mm), uneven impregnation with a resin was obtained and a reduction in strength was observed. It was also clarified that when the width of the tow exceeded 4.0 (mm), a necessary strength became obtained and further, when the width of the tow exceeded 6.0 (mm), sufficient strength was obtained.

As is explained above, the fiber-reinforced plastic molded articles according to the invention are produced by feeding fibers in the pull system and are therefore superior in production efficiency. Also, reinforced fiber is fed in a substantially untwisted state even if it is fed in the pull system and therefore the resulting molded articles have high strength because the strength characteristics of the reinforced fiber are sufficiently exhibited.

1. A fiber-reinforced plastic molded body produced by feeding a reinforced fiber bundle in a vertical pulling-out system from a reinforced fiber wound body, being characterized in that;
the reinforced fiber bundle wound around the reinforced fiber wound body for feeding in the vertical pulling-out system is constituted of 10000 or more pieces of component fiber and twisted in reverse with respect to a direction of twists given thereto when fed in the vertical pulling-out system, and the number of twists is almost the same as that given when the fiber bundle is fed in the vertical pulling-out system and;
the number of twists in the reinforced fiber bundle contained in the plastic molded body is substantially zero.

2. A fiber-reinforced plastic molded body according to claim 1, wherein the width W of the reinforced fiber bundle to be fed from the reinforced fiber wound body is 4.0 (mm) or more.

3. A fiber-reinforced plastic molded body according to claim 1, wherein the width W of the reinforced fiber bundle to be fed from the reinforced fiber wound body is 6.0 (mm) or more.

4. A fiber-reinforced plastic molded body according to any one of claims 1 to 3, wherein the reinforced fiber bundle has a tow strength of 4.0 GPa or more and an elastic modulus of 220 GPa or more.

5. A method for producing a fiber-reinforced plastic molded body by feeding a reinforced fiber bundle from a reinforce wound body in a vertical pulling-out system, being characterized in that;
said reinforced fiber bundle is constituted of 10000 or more monofilaments; and
said reinforced fiber to be wound around said reinforced fiber wound body for feeding in the vertical pulling-out system is provided with twists which are the same in number as twists given when fed in the vertical pulling-out system and are given in reverse with respect to a direction of the twists given when fed.

6. A method for producing a fiber-reinforced plastic molded body according to claim 5, wherein the width W of the reinforced fiber bundle to be fed from the reinforced fiber wound body is 4.0 (mm) or more.

7. A method for producing a fiber-reinforced plastic molded body according to claim 5, wherein the width W of the reinforced fiber bundle to be fed from the reinforced fiber wound body is 6.0 (mm) or more.

8. A method for producing a fiber-reinforced plastic molded body according to any one of claims 5 and 6, wherein said reinforced fiber bundle has a tow strength of 4.0 GPa or more and an elastic modulus of 220 GPa or more.
